(19) United States
(12) Patent Application Publication
(10) Pub. No.: US 2008/0037930 A1
(43) Pub. Date: Feb. 14, 2008

(54) TAPPABLE CABLE SEGMENT FOR COMMUNICATION INFRASTRUCTURE

(75) Inventors: Alain Perrin, Saint Nicolas De Macherin (FR); Sebastian Schreiber, Berlin (DE); Hannes Bauer, Dortmund (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Schneider Electric Industries SAS, Rueil-Malmaison (FR)

(21) Appl. No.: 11/680,209

(22) Filed: Feb. 28, 2007

(30) Foreign Application Priority Data
Mar. 21, 2006 (FR) 06 50962

(51) Int. Cl. G02B 6/44; G02B 6/26

(52) U.S. Cl. 385/15; 385/100; 398/58; 398/61

(57) ABSTRACT

The present invention relates to a cable segment (2) in a communication infrastructure, comprising:
several groups (21) of optical fibres,
a first connector (22a) situated at one end of the segment (2), presenting connection zones (3a, 3b, 3c, 3d),
a second connector (22b) situated at the other end of the segment (2) presenting connection zones (30a, 30b, 30c, 30d) complementary to those of the first connector (22a). The groups of optical fibres (21) comprise:
one or more groups (21b, 21c, 21d) of continuous optical fibres along the segment,
a group (21a) of tap-off optical fibres, each optical fiber (210) of this group being interrupted once so as to form a tapping point (23) of the segment.

### BACKGROUND OF THE INVENTION

1. Field of the Invention

The present invention pertains to a tappable cable segment for a communication infrastructure, comprising several groups of optical fibres. The invention also relates to a communication infrastructure comprising at least one cable segment. The infrastructure may comprise several segments connected end to end.

2. Description of the Prior Art

A computer communication infrastructure operating under a protocol for example of Ethernet, ATM or Token Ring type can present several different topologies. The best known ones are the star, bus or ring topologies.

In a star topology, servers are linked to a main hub spreading out via several star branches towards several secondary items of equipment to which computer terminals are for example connected directly or by way of network switches. Typically, in a local infrastructure, the main hub is installed in a central area of a building and the secondary items of equipment are located remotely in areas situated as near as possible to the computer terminals of the end users.

The branches linking the main hub to the secondary items of equipment are for example made of optical fibres. With respect to a coaxial cable or to a twisted pair, the optical fiber allows much higher throughputs that may go beyond 1 gigabit per second. Furthermore, it presents numerous other advantages related in particular to the immunity of the signal along the optical fiber, to the reliability and to the sureness of transmission over long distances.

However, when a new secondary item of equipment has to be installed and linked to the main hub, the star topology makes it necessary to trunk a new fiber optic cable from the main hub to the secondary item of equipment. But, the bespoke installation of a fiber optic cable is often expensive and must be entrusted to specialists.

A communication infrastructure presenting a bus topology makes it possible to remedy this problem. In a bus topology, a single cable is connected to the main hub and this cable presents several tappings leading to the secondary items of equipment. The quantity of cable to be trunked between the bus and the secondary items of equipment is therefore reduced and the infrastructure is easier to install. However, when the cable is made of optical fibres, each tapping performed on the optical fibres towards a secondary item of equipment gives rise to an attenuation of the signal. Moreover, currently, to perform a tapping on a fiber optic cable turns out to be technically difficult to implement.

### SUMMARY OF THE INVENTION

The aim of the invention therefore is to be able to construct a communication infrastructure based on optical fibres in a simple manner, that is to say without trunking numerous cables and without calling upon specialists, while guaranteeing the end user optimal quality of service.

This aim is achieved by a cable segment in a communication infrastructure, comprising:
several groups of optical fibres, the groups each comprising one and the same quantity of optical fibres,
a first connector situated at one end of the segment, presenting connection zones,
a second connector situated at the other end of the segment presenting connection zones complementary to those of the first connector, the first and second connectors each grouping together the set of optical fibres, characterized in that the groups of optical fibres comprise:
one or more groups of continuous optical fibres along the segment,
a group of tap-off optical fibres, each optical fiber of this group being interrupted once so as to form a tapping point of the segment, and in that
the first connector presents a first connection zone linked to the group of tap-off fibres, the connection zone complementary to this first connection zone on the second connector being linked to a group of continuous fibres,
the first connector presents a second connection zone linked to a group of continuous fibres, the connection zone complementary to this second connection zone on the second connector being linked to the group of tap-off fibres.

A communication infrastructure constructed on the basis of segments according to the invention seems to present a bus topology since each segment presents several tapping points. However, this infrastructure operates in reality according to a star topology. The infrastructure according to the invention therefore comprises in particular the advantages related to the ease of installation of a bus topology but also those related to the quality of service specific to a star topology infrastructure.

According to the invention, the segment comprises several tapping points staggered along the segment. The construction of a local computer communication infrastructure is therefore easy, since it is carried out by simple abutting of several segments. Furthermore, adding a secondary item of equipment does not present any difficulty since each segment has tapping points pre-equipped with connectors. The tapping of the optical fiber thus makes it possible to bring a signal with a large throughput at least as far as the secondary item of equipment and therefore as near as possible to the terminal of the end user.

According to one feature, at each tapping point the interrupted optical fiber presents two optical terminations united in a common connector.

According to another feature, at the tapping point the tapping is carried out perpendicularly or parallel to the segment of optical fibres.

According to another feature, the first and second connectors are multi-fiber.

According to another feature, it comprises four groups of six optical fibres each.

According to another feature, the communication infrastructure is of simple star type.

The aim of the invention is also to propose a communication infrastructure comprising at least one hub linked to a first end of a transmission line comprising at least one cable segment such as defined above, the said hub being able to send data on each optical fiber of the transmission line at throughputs suited to the secondary items of equipment that are potentially different from one another.

According to one feature, the transmission line presents a second end joined to the hub by an optical transport cable.

According to another feature, the transmission line presents a second end to which the groups of optical fibres are linked two by two by way of a looping connector.

According to another feature, the hub comprises a multi-fiber connector for connecting one end of the transmission line.

According to another feature, the transmission line comprises several segments connected end to end or interconnected by way of one or more transport cables.

This communication infrastructure is particularly suitable for operating under a protocol allowing the transfer of data by optical fibres such as for example Ethernet, ATM or “Token Ring”.

According to another feature, the infrastructure is of simple star type.

According to the invention, the use of segments of the type described in this patent application therefore allows great modularity in the assembly and installation of a communication infrastructure.

### BRIEF DESCRIPTION OF THE DRAWINGS

Other characteristics and advantages will appear in the detailed description which follows while referring to an embodiment given by way of example and represented by the appended drawings in which:

FIG. 1 represents in a diagrammatic manner a communication infrastructure according to the invention,

FIG. 2 represents two cable segments according to the invention placed end to end,

FIG. 3 represents in a diagrammatic manner a variant of the communication infrastructure according to the invention,

FIG. 4 represents a looping connector usable in a communication infrastructure according to the invention,

FIG. 5 represents a variant of the tapping point of a segment according to the invention,

FIG. 6 diagrammatically represents a tapping point of a segment to which a secondary item of equipment is connected.

### DETAILED DESCRIPTION

A local computer communication infrastructure operating under a protocol allowing the transfer of data by optical fibres such as for example Ethernet, ATM or “Token Ring” comprises at the head end a main hub 1, for example active, presenting input connections 10 for receiving various inputs, in particular optical, originating from servers and output connections 11 transmitting optical signals, for example in parallel, on several optical fibres of a transmission line. The output connections 11 are multi-fiber connectors of MPO (Multi-fibres Push-On), MF or MTP (trademark) type suited to the MPO (Multi-fibres Push-On), MF or MTP (trademark) connection system of the transmission line. MTP, MF and MPO connectors being well known, they are not described in this patent application.

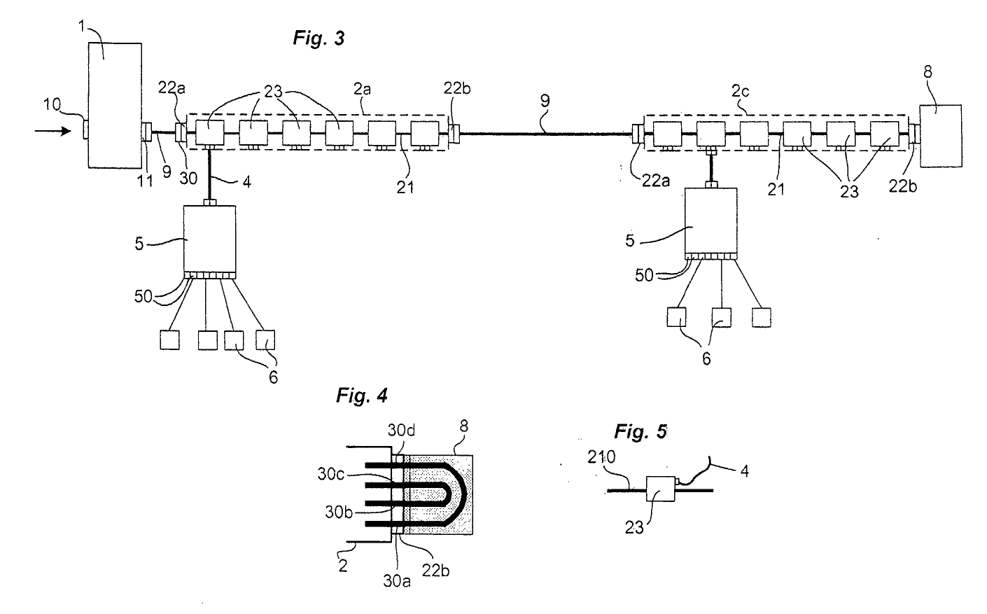

According to the invention, the fiber optic transmission line is composed of several identical fiber optic segments 2a, 2b, 2c, 2d (hereafter 2) connected end to end (FIG. 1) or possibly linked together by one or more optical transport cables 9 (FIG. 3). The optical fibres employed are for example of OM2 type.

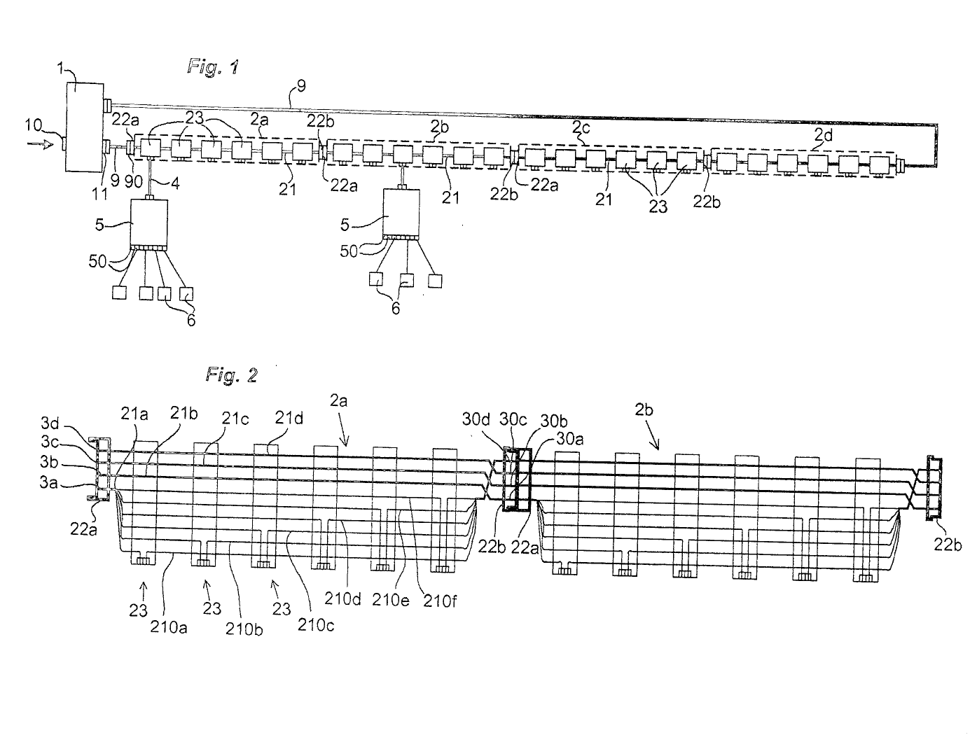

With reference to FIG. 2, each segment 2 of cable consists for example of a cable or of a flexible conduit, traversed along its axis by several groups 21a, 21b, 21c, 21d (hereafter 21) of parallel optical fibres, for example four groups 21 of optical fibres. Each group 21 of optical fibres comprises one and the same quantity of optical fibres, for example six optical fibres 210a, 210b, 210c, 210d, 210e, 210f (hereafter 210). The arrangement of the groups 21 of optical fibres in a conduit can in particular present advantages in the method of manufacture of the segment 2 of the invention.

At each of its ends the segment 2 presents a first connector 22a and a second connector 22b each grouping together the optical fibres 210 of the segment. These two end connectors 22a, 22b are multi-fiber connectors for example of MPO (for “Multi-fibres Push-On”), MF or MTP type. One of the two end connectors 22a, 22b is for example a male connector while the other end connector is a female connector, so that the two connectors 22a, 22b present complementary connection zones 3a, 3b, 3c, 3d, 30a, 30b, 30c, 30d (FIG. 2). The first connector 22a situated at the head end makes it possible to connect the segment 2a directly to a complementary connector 11 of the main hub 1 or to a complementary connector 90 of a multi-fiber optical transport cable 9 (FIG. 1). The second connector 22b of the segment 2a is able to receive the complementary connector 22a of an adjacent identical segment 2b (FIG. 1) or that of an optical transport cable 9 for example leading to another segment 2c (FIG. 3). If a segment 2 conducts four groups 21 of six optical fibres 210 each, the end connectors 22a, 22b of each segment 2 and the connectors of the optical transport cables 9 have twenty-four fibres.

An optical transport cable 9 is an uninterrupted cable presenting multi-fiber connectors for example of MPO, MF or MTP type suited in particular to the end connectors 22a, 22b of the segments 2 and to the output connections 11 of the main hub 1.

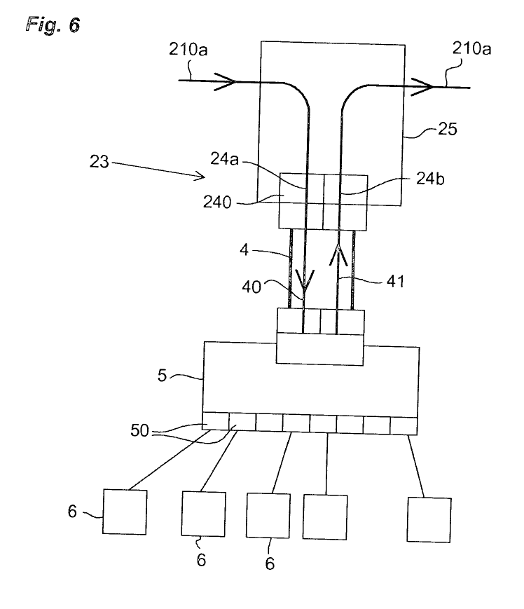

In a segment 2a of cable, the optical fibres 210 of a single group 21a are tapped off (FIG. 2). The optical fibres of the other groups 21b, 21c, 21d are continuous along the segment 2a. In the group 21a of tap-off fibres, each optical fiber 210a, 210b, 210c, 210d, 210e, 210f of the group is interrupted once so as to form a tapping point 23 (also called derivation point or dropping point) with two optical terminations 24a, 24b, a termination of the incoming optical fiber and a termination of the outgoing optical fiber (FIG. 6).

The optical terminations 24a, 24b are linked to optical connections for example comprising a monofiber distinct optical connector for each termination 24a, 24b or a common optical connector 240 with two fibres grouping together the two terminations 24a, 24b as represented in FIG. 6. These optical connections are accommodated in a housing 25 mounted on the segment 2a.

According to the invention, the tapping of each optical fiber 210 can be oriented perpendicularly to the cable (FIGS. 1 and 3) or parallel to the latter (FIG. 5) according to the orientation of the optical connector 240 in the housing 25.

A cable 4 of the optical jumper type presenting two optical fibres 40, 41 and leading for example to a secondary item of equipment 5 that may also be active, can thus be connected to each of the tapping points 23 of a segment 2 (FIGS. 1, 3 and 6). This cable 4 presents a connection system complementary to that of the optical connections of a tapping point 23 of a segment 2. In FIGS. 1 and 3, each secondary item of equipment 5 connected at a tapping point 23 of a segment 2 is an item of equipment of a topology of simple star type.

The tapping points 23 are staggered along the segment 2 of cable. Each segment 2 for example comprises four groups 21 of six optical fibres each and therefore at least six tapping points 23 distributed over the whole of its length. On each segment 2, it is therefore possible to connect six secondary items of equipment 5. Each secondary item of equipment 5 for example comprises eight ports 50 allowing each to directly link a computer terminal 6 or possibly several computer terminals (not represented).

Of course, it is possible to envisage making a segment 2 presenting more or less than four groups 21 of optical fibres 210 with more or less than six optical fibres per group. The number of groups of fibres as well as the quantity of fibres per group will have to be suited to the types of end connectors available.

According to the invention, each segment 2 comprises one or more groups 21b, 21c, 21d of continuous optical fibres along the segment, for example three in FIG. 2, and a group 21a of tap-off optical fibres in which, as described above, each optical fiber 210 of the group is tapped off once.

According to the invention, the first end connector 22a of a segment 2 comprises connection zones 3a, 3b, 3c, 3d complementary to connection zones 30a, 30b, 30c, 30d of the second end connector 22b so as to be able to place end to end several identical segments 2 (FIG. 1) possibly linked together by optical transport cables 9. Each connection zone for example comprises several connection points, each connection point being associated with an optical fiber.

In a segment, the groups 21 of optical fibres are linked to the two end connectors 22a, 22b so that, if several identical segments 2a, 2b 2c, 2d of cable are placed end to end, a group 21a whose optical fibres are tapped off in a segment 2a is extended into the adjacent segments 2b, 2c, 2d by continuous optical fibres.

More precisely, with reference to FIG. 2, in each segment 2, a first group 21d of continuous optical fibres is on the one hand linked to the first connection zone 3d of the first end connector 22a and on the other hand to the second connection zone 30c of the second end connector 22b. A second group 21c of continuous optical fibres is linked on the one hand to the second connection zone 3c of the first end connector 22a and on the other hand to the third connection zone 30b of the second end connector 22b. A third group 21b of continuous optical fibres is linked on the one hand to the third connection zone 3b of the first end connector 22a and on the other hand to the fourth connection zone 30a of the second end connector 22b. Finally, the group 21a of tap-off optical fibres is linked on the one hand to the fourth connection zone 3a of the first end connector 22a and on the other hand to the first connection zone 30d of the second end connector 22b.

As a result of this arrangement, at each new connected segment 2, the groups 21 of optical fibres are shifted with respect to one another. Thus, in a transmission line comprising four segments 2a, 2b, 2c, 2d placed end to end (FIG. 1), the first group 21d of continuous fibres of the first segment 2a is connected to the second group of continuous fibres 21c of the second segment, which is itself connected to the third group of continuous fibres 21b of the third segment 2c and which is itself connected to the group 21a of tap-off fibres of the fourth segment 2d. Likewise the second group 21c of continuous fibres of the first segment 2a is connected to the third group 21b of continuous fibres of the second segment 2b, which is itself connected to the group 21a of tap-off fibres of the third segment 2d and which is itself connected to the first group 21d of continuous fibres of the fourth segment. The third group 21b of continuous fibres of the first segment 2a is connected to the group 21a of tap-off fibres of the second segment, which is itself connected to the first group 21d of continuous fibres of the third segment and which is itself connected to the second group 21c of continuous fibres of the fourth segment 2d. The group 21a of tap-off fibres of the first segment 2a is connected to the first group 21d of continuous fibres of the second segment 2b, which is itself connected to the second group 21c of continuous fibres of the third segment 2c and which is itself connected to the third group 21b of continuous fibres of the fourth segment 2d.

Such an arrangement of the groups 21 of optical fibres in a segment 2 makes it possible to easily make an optical transmission line composed of several identical segments 2a, 2b, 2c, 2d placed end to end or possibly linked together by one or more optical transport cables 9 (FIG. 3).

Along a transmission line composed of several segments 2, each optical fiber 210 of a group can be tapped off only once thereby making it possible to guarantee compliance of the star topology and conformity to the standard in respect of each secondary item of equipment 5 connected to a tapping point 23. The transmission line cannot comprise more segments 2 than groups 21 of optical fibres present in a segment 2. In FIG. 2, the segments 2a, 2b each comprise four groups 21a, 21b, 21c, 21d of optical fibres, the transmission line can therefore comprise at most only four segments 2a, 2b, 2c, 2d connected end to end or possibly linked together by one or more optical transport cables 9 (FIG. 1).

A communication infrastructure including one or more segments 2 according to the invention can be embodied according to the following variants:

According to a first variant embodiment represented in FIG. 1, the hub 1 is connected to the transmission line and sends signals to the optical fibres of the line, the transmission line is looped back with the aid of a multi-fiber optical transport cable 9 connected to the end connector 22b of the tail segment 2d so as to link the transmission line to the main hub 1 and thus convey the outgoing signals leaving the secondary items of equipment 5 to the main hub 1. In this variant, each secondary item of equipment connected is an item of equipment of a topology of simple star type.

According to a second variant embodiment represented in FIGS. 3 and 4, it is possible to envisage, at the end of the transmission line thus built, a looping connector 8 connected to the end connector 22b of the tail segment 2c. This type of connector 8 can make it possible to circumvent the transport cable 9 designed for the return when not all the segments 2 are deployed. This looping connector 8 makes it possible to link the optical fibres together, pairwise. With reference to FIG. 4, by way of this looping connector 8, the optical fibres of a group 21 that are connected to the first connection zone 30d of the end connector 22b are linked to the optical fibres of another group 21 that are connected to the fourth connection zone 30a of this end connector 22b and the optical fibres of a group 21 that are connected to the second connection zone 30c of the end connector are linked to the optical fibres of another group 21 that are connected to the third connection zone 30b of the end connector 22b. In order to be able to ensure the return of signals to the main hub 1, it will be possible to use the connector 8 only when the transmission line comprises a number of segments 2 at most equal to half the number of optical fiber groups 21 in a segment 2. In this variant, each secondary item of equipment connected is an item of equipment of a topology of simple star type.

It is of course understood that it is possible, without departing from the scope of the invention, to contemplate other variants and refinements of detail and even to envisage the use of equivalent means.

1. Cable segment (2) in a communication infrastructure, comprising:
several groups (21) of optical fibres, the groups each comprising one and the same quantity of optical fibres (210),
a first connector (22a) situated at one end of the segment (2), presenting connection zones (3a, 3b, 3c, 3d),
a second connector (22b) situated at the other end of the segment (2) presenting connection zones (30a, 30b, 30c, 30d) complementary to those of the first connector (22a), the first and second connectors (22a, 22b) each grouping together the set of optical fibres (210), wherein the groups (21) of optical fibres comprise:
one or more groups (21b, 21c, 21d) of continuous optical fibres along the segment,
a group (21a) of tap-off optical fibres, each optical fiber (210) of this group being interrupted once so as to form a tapping point (23) of the segment, and in that
the first connector (22a) presents a first connection zone (3a) linked to the group (21a) of tap-off fibres, the connection zone (30a) complementary to this first connection zone on the second connector (22b) being linked to a group (21b) of continuous fibres,
the first connector (22b) presents a second connection zone (3d) linked to a group (21d) of continuous fibres, the connection zone (30d) complementary to this second connection zone on the second connector being linked to the group (21a) of tap-off fibres.

2. Segment according to claim 1, wherein, at each tapping point (23), the interrupted optical fiber presents two optical terminations (24a, 24b) united in a common connector (240).

3. Segment according to claim 1 or 2, wherein, at the tapping point (23), the tapping is carried out perpendicularly or parallel to the segment of optical fibres.

4. Segment according to one of claims 1 to 3, wherein the first and second connectors (22a, 22b) are multi-fiber.

5. Segment according to one of claims 1 to 4, wherein it comprises four groups (21a, 21b, 21c, 21d) of six optical fibres (210a, 210b, 210c, 210d, 210e, 210f) each.

6. Segment according to one of claims 1 to 5, wherein the communication infrastructure is of simple star type.

7. Communication infrastructure, wherein it comprises at least one hub (1) linked to a first end of a transmission line comprising at least one cable segment (2) according to one of claims 1 to 6, the said hub being able to send data on the optical fibres (210) of each group (21) of the transmission line.

8. Infrastructure according to claim 7, wherein the transmission line presents a second end joined to the hub (1) by an optical transport cable (9).

9. Infrastructure according to claim 7, wherein the transmission line presents a second end to which the groups (21) of optical fibres are linked two by two by way of a looping connector (8).

10. Infrastructure according to one of claims 7 to 9, wherein the hub (1) comprises a multi-fiber connector (11) for connecting one end of the transmission line.

11. Infrastructure according to one of claims 7 to 10, wherein the transmission line comprises several segments (2a, 2b, 2c, 2d) connected end to end or interconnected by way of one or more transport cables (9).

12. Infrastructure according to one of claims 7 to 11, wherein it is of simple star type.
